(19) United States
(12) Patent Application Publication
(10) Pub. No.: US 2013/0132016 A1
(43) Pub. Date: May 23, 2013

(54) OPTIMIZING DEPLOYMENT OF A DATA LOGGER

(71) Applicants: Jeff Dennis, Sandwich, MA (US); Jacob Lacourse, Middleboro, MA (US); Nick Lowell, North Falmouth, MA (US); Mark Hruska, Bourne, MA (US); Robert Ryan, East Falmouth, MA (US)

(72) Inventors: Jeff Dennis, Sandwich, MA (US); Jacob Lacourse, Middleboro, MA (US); Nick Lowell, North Falmouth, MA (US); Mark Hruska, Bourne, MA (US); Robert Ryan, East Falmouth, MA (US)

(73) Assignee: ONSET COMPUTER CORPORATION, Pocasset, MA (US)

(21) Appl. No.: 13/302,867

(22) Filed: Nov. 22, 2011

(51) Int. Cl. G06F 19/00

(52) U.S. Cl. 702/85

(57) ABSTRACT

A method of optimizing deployment of a data logger includes detecting energy that is in proximity to the data logger and presenting a representation of the detected energy to a user so that the user can provide an indication of deployment optimization that can trigger capturing a plurality of energy values that can be used to determine a range of energy values from a portion of the plurality of energy values that are indicative of an on condition associated with the energy.

### BACKGROUND OF THE INVENTION

1. Field

The methods and systems of optimizing deployment of a data logger disclosed herein generally relate to data logger deployment. These same methods and systems more particularly relate to automation of a calibration process for in situ optimization of data logger deployment.

2. Description of the Related Art

Properly positioning a data logger to ensure that a sensor of the data logger is properly exposed to a data logging target, such as illumination from a switched light is considered an important step in optimizing deployment of a data logger. Trial and error of data logger positioning that is based on the deployer's best effort with little feedback often results in higher costs and less reliable target sensing. Solutions that offer some sort of feedback during positioning for calibrating monitoring devices typically require a connection to external hardware or do not provide enough feedback to ensure that deployment is being optimized so that a good calibration value(s) can be captured through the data logger sensor. In addition, calibrating a data logger's sensing circuitry via hardware determined thresholds (e.g. by turning a potentiometer, and the like) not only requires tools to be used during deployment solely for calibration, but requires access to the data logger with such a tool, which often limits where the data logger can be positioned.

### SUMMARY OF THE INVENTION

The methods and systems may allow a user to calibrate a data logger that is deployed for data collection in an application in the field as many times as necessary to achieve reliable readings to accurately detect on and/or off states of a sensed device or energy field. A user may deploy a device in an environment where ambient conditions may affect an un-calibrated data logger. However, with a reliable auto calibration enabled data logger, those ambient conditions can be filtered out such that the data logging target is the only thing that influences the detection of state changes for logging. An automatic calibration enabled data logger also provides the user with instantaneous feedback before during and after automatic calibration of the likelihood of success or failure of calibration. Prior to calibration, the feedback facilitates deployment of the data logger to ensure proper exposure of the data logger sensor to the sensed energy/apparatus by with a continuous representation of sensed signal strength. During calibration the feedback indicates sensed signal strength along with calibration progress. After calibration, the feedback continues to show sensed signal strength along with a result of calibration. If calibration is unsuccessful the user can immediately choose to use the default or prior good calibration value(s) (typically a factory setting) or recalibrate the device using the integrated automatic calibration capability. Required calibration follows a simplified process that takes advantage of sophisticated firmware algorithms being executed during the calibration process, the feedback (visual, audible, etc), and a one touch calibration function. The combination of these three elements make calibration intuitive and easy to use from the user's perspective.

In addition, no tools are required to perform calibration. This may improve safety related to data logger deployment because a technician deploying a data logger may not have to be standing on a ladder while holding the data logger and trying to adjust a potentiometer, particularly in environments that include moving parts or potentially dangerous conditions, such as motors, spinning belts, and the like.

Calibration as referred to herein may include learning a deployment environment for reliably detecting at least on and off conditions associated with detectable energy in the environment. The methods and techniques herein may include capturing a snapshot of an environment to facilitate determining on and/or off conditions of sensed signals that are associated with the environment. Calibration as referred herein may also include setting one or more levels associated with data logging in the environment, wherein the levels may be indicative of at least on one of an on condition and an off condition of a source or presence of energy that is detectable in the environment.

Methods and systems in this disclosure include a method of automatic calibration of a data logger during deployment of the data logger. The method includes a method of optimizing deployment of a data logger that includes detecting with the data logger energy that is in proximity to the data logger; presenting a representation of the detected energy to a user; receiving an indication of deployment optimization while presenting the representation of the detected energy to the user; capturing a plurality of energy values in response to receiving the indication of deployment optimization; and determining a range of energy values from a portion of the plurality of energy values that are indicative of at least one of an on and an off condition associated with the energy.

Methods and systems in this disclosure include a data logger that is capable of automatically calibrating to detect at least one of an on and an off condition. The methods and systems further include a data logger that is capable of automatically detecting at least one of an on and an off condition. The data logger includes a sensor for detecting energy that is in proximity to the data logger; an output facility for presenting a representation of the detected energy to the user; an input facility for facilitating user input; and a processor for detecting the user input, capturing a plurality of energy values via the sensor in response to the detected user input, and processing a portion of the captured plurality of energy values to determine a range of energy values that are indicative of at least one of an on and an off condition associated with the energy.

Methods and systems in this disclosure also include a user method of optimizing deployment of a data logger that includes the steps of: positioning a data logger that is capable of automatically determining a range of energy values that indicate at least one of an on and an off condition associated with energy that is in proximity to the data logger; viewing a representation of energy that is detected by the data logger while the energy is being detected by the data logger; adjusting a position of the data logger so that the representation is maintained above a minimum auto-calibration threshold; and signaling to the data logger to begin auto calibration.

The methods and systems disclosed herein may include storing a range of data values that are indicative of at least one of an on condition and an off condition in the data logger. Storing the range of data values may facilitate detecting with the data logger both an on condition and an off condition of the energy during run-time. Alternatively, storing the range of data values may include establishing an automatic calibration value(s) within the data logger.

The methods and systems described herein may include automatically detecting at least one of an on and an off condition of energy that is emitted from a device. In the methods and systems, the device may emit any of light energy, electromagnetic energy, artificial light, wavelength-specific energy, narrowband UVB light, sunlight, a chemical, electromagnetic radiation, radio frequency radiation, sound, and the like. In these methods and systems, at least one of an on condition and an off condition may be associated with presence of sound, volume of sound above a threshold, presence of a characteristic of the sound, and the like. In the methods and systems, the device may generate pressure, may produce humidity, may control temperature, may generate a rotational force, may move so that the data logger detects velocity or acceleration of the moving device (e.g. tilt, position, impact, shock, vibration, free-fall), may carry a current, may carry a voltage, may present a measurable resistance, impedance, conductance, may impact lux, may impact barometric pressure. In the methods and systems, energy may be detected from a device that is disposed in a medium, such as air, water, or other liquid.

In the methods and systems disclosed herein, determining a range of energy values for detecting at least one of an on and an off condition may be in response to receiving a user input to the data logger. Determining the range may further include the steps of receiving a user input to calibrate the data logger; capturing a plurality of detected energy values; filtering out values below a minimum calibration threshold; determining a nominal value of the non-filtered values; and applying a hysteresis rule to generate the range of energy values.

Further in the methods and systems disclosed herein, the range of energy values may include hysteresis associated with at least one of an on condition and an off condition. The hysteresis may be based on predetermined parameters, such as units of detected energy, percent of detected energy, and the like. Hysteresis may include a positive range that is different than a negative range relative to a nominal detected value associated with at least one of an on condition and an off condition. Alternatively, the hysteresis may be determined based on a hysteresis determination rule. Such a hysteresis determination rule may include at least one of energy emitting device type, data logger aspects, a nominal detected energy value, a minimum detectable value, and the like.

The methods and systems disclosed herein may include a representation of the detected energy that presents the detected energy on a scale of detectable energy. The representation may be displayed on an electronic display and wherein the scale is a bar graph. Alternatively, the representation may include generating audio. In this method, the scale may be volume, pitch, repetition rate, tone length, and the like.

In the methods and systems described herein, presenting a representation of the detected energy may include presenting the detected energy as a percent of energy that is detectable by the data logger. Alternatively, the detected energy may be presented as a representation of a potential nominal value associated with at least one of an on condition and an off condition. Yet alternatively, presenting a representation of the detected energy may include presenting an indication that the detected energy is below a minimum value for determining a range of energy values that indicate at least one of an on and an off condition of the device.

In the methods and systems described herein, the energy may be any of light energy, electromagnetic energy, artificial light, wavelength specific energy, narrowband UVB light, sunlight, electromagnetic radiation, radio frequency radiation, sound, pressure, humidity, temperature, rotation force, velocity, acceleration, vibration, voltage, current, lux, barometric pressure, chemical concentration in a medium, and the like.

The methods and systems described herein include a method of optimizing deployment of a data logger, that includes detecting with the data logger energy that is in proximity to the data logger; presenting a representation of the detected energy to a user; receiving an indication of deployment optimization while presenting the representation of the detected energy to the user; capturing a plurality of energy values in response to receiving the indication of deployment optimization; and determining a range of energy values from a portion of the plurality of energy values that are indicative of an on condition associated with the energy. The method further includes storing a range of data values that are indicative of the on condition in the data logger.

In the method, determining a range of energy values is in response to receiving a user input by the data logger. Further in the method, determining a range of energy values that indicate an on condition associated with the energy includes filtering out values below a minimum calibration threshold; determining a nominal value of the non-filtered values; and applying a hysteresis rule to generate the range of energy values.

In the method, the range of energy values includes hysteresis associated with the on condition. Further in the method, the hysteresis is based on predetermined parameters. The predetermined parameters are units of detected energy or percent of detected energy. Further in the method, positive hysteresis is different than negative hysteresis relative to a nominal detected value associated with the on condition. In the method hysteresis is determined based on a hysteresis determination rule. The hysteresis determination rule includes at least one of energy emitting device type, data logger aspects, a nominal detected energy value, and a minimum detectable value.

Also in the method, presenting a representation of the detected energy includes presenting the detected energy on a scale of detectable energy. In this method, presenting a representation includes generating audio, wherein the scale may be volume, pitch, repetition rate, or tone length.

Alternatively in the method, presenting a representation of the detected energy includes presenting the detected energy as a percent of energy that is detectable by the data logger. Presenting a representation may alternatively indicate a potential nominal value associated with the on condition. In an alternate embodiment of the method, presenting a representation of the detected energy includes presenting an indication that the detected energy is below a minimum value for determining a range of energy values that indicate an on condition of the device. Presenting a representation of the detected energy may include presenting an indication of quality of the energy, such as an indication of variability over time or an indication of variability over a plurality of samples.

In the method the detected energy may be electromagnetic energy.

In the method the detected energy is emitted from a source. The source may emit electromagnetic energy.

In the method, receiving an indication of deployment optimization includes receiving user input.

In the method, the detected energy is any of light energy, artificial light, wavelength specific energy, narrowband UVB light, sunlight, chemical concentration in a medium (e.g. air or liquid), electromagnetic radiation, radio frequency radiation, sound, pressure, humidity, temperature, rotation force, velocity, acceleration, vibration, voltage, current, lux, barometric pressure, presence of sound, volume of sound above a threshold, or presence of a characteristic of the sound.

The method may further include storing a range of data values that are indicative of the on condition in the data logger. Storing the range of data values facilitates detecting with the data logger both an on condition and an off condition of the energy during run-time. Alternatively, storing the range of data values includes establishing an automatic calibration value(s) within the data logger.

The methods and systems described herein may include a data logger for automatically detecting an on condition that includes a sensor for detecting energy that is in proximity to the data logger; an output facility for presenting a representation of the detected energy to the user; an input facility for facilitating user input; and a processor for detecting the user input, capturing a plurality of energy values via the sensor in response to the detected user input, and processing a portion of the captured plurality of energy values to determine a range of energy values that are indicative of an on condition associated with the energy. The data logger may further include a storage facility for storing the range of energy values that are indicative of the on condition in the data logger. The range of energy values includes hysteresis associated with the on condition. Also, the hysteresis is determined based on a hysteresis determination rule. Alternatively in the data logger, a representation of the detected energy includes an energy scale representation on an electronic display and wherein the scale is a bar graph.

The methods and systems described herein may include a method of optimizing deployment of a data logger that includes positioning a data logger that is capable of automatically determining a range of energy values that indicate an on condition associated with energy that is in proximity to the data logger; viewing a representation of energy that is detected by the data logger while the energy is being detected by the data logger; adjusting a position of the data logger so that the representation is maintained above a minimum auto-calibration threshold; and signaling to the data logger to begin auto calibration.

In this method, a representation of the energy that is detected by the data logger indicates a potential nominal value associated with the on condition. Alternatively, a representation of the energy that is detected by the data logger includes an indication that the detected energy is below a minimum value for determining a range of energy values that indicate an on condition of the device. In yet another embodiment, of this method a representation of the energy that is detected by the data logger includes an indication of quality of the energy.

In this method the energy that is detected by the data logger is electromagnetic energy.

This method may further include storing a range of data values that are indicative of the on condition in the data logger. Storing the range of data values facilitates detecting with the data logger both an on condition and an off condition of the energy during run-time. Alternatively, storing the range of data values includes establishing an automatic calibration value(s) within the data logger.

In this method, the energy that is detected by the data logger is emitted from a source. The source may emit, generate, produce, impact or carry any of light energy, electromagnetic energy, artificial light, wavelength specific energy, narrowband UVB light, sunlight, a chemical, electromagnetic radiation, radio frequency radiation, sound, pressure, humidity, a rotational force, movement, a vibration, voltage, current, lux in proximity to the device, barometric pressure. The source may impact temperature. The data logger may detect velocity of the source or acceleration of the source.

In this method, the on condition is associated with presence of sound, volume of sound above a threshold, or presence of a characteristic of the sound.

Further in this method a representation of the detected energy includes the detected energy presented as a scale of detectable energy. The representation includes an audio scale that may be one of volume, pitch, repetition rate, and tone length. Alternatively in this method, a representation is presented on an electronic display and wherein the scale is a bar graph. The representation of the detected energy includes the detected energy as a percent of energy that is detectable by the data logger. The representation of the detected energy may alternatively indicate a potential nominal value associated with the on condition. Yet alternatively, the representation of the detected energy includes an indication that the detected energy is below a minimum value for determining a range of energy values that indicate an on condition of the device. In this method the representation of the detected energy includes an indication of quality of the energy that may be an indication of variability over time or an indication of variability over a plurality of samples.

In this method, the energy detect by the data logger is any of light energy, electromagnetic energy, artificial light, wavelength specific energy, narrowband UVB light, sunlight, chemical concentration in a medium (e.g. air or liquid), radio frequency radiation, sound, pressure, humidity, temperature, rotation force, velocity, acceleration, vibration, voltage, current, lux, or barometric pressure. In this method, the on condition maybe based on presence of sound, volume of sound above a threshold, or presence of a characteristic of the sound.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts optimizing deployment of a data logger;

FIG. 2 depicts a flow diagram of a method of determining at least one of an on and an off condition of sensed energy with a data logger;

FIG. 3 depicts a perspective view of an embodiment of an auto-calibration enabled data logger;

FIG. 4 depicts a series of auto calibration screen shots;

FIG. 5 depicts at least one of an on and an off condition determined from a plurality of sensed data points; and

FIG. 6 depicts an auto-calibration enabled data logger in an environment.

### DETAILED DESCRIPTION OF THE PREFERRED EMBODIMENT(S)

A data logger system that is capable of automatically calibrating for real world deployment environments may facilitate automatically determining a range of sensed energy values that are indicative of at least one of an on and an off condition associated with the sensed energy values. Such an auto-calibration capable data logger system may facilitate optimizing deployment of the data logger through an easy to use one-touch calibration function that may combine presentation of sensed energy values with sophisticated on/off condition detection and hysteresis determination algorithms. Automatic determination of a subset of a range of sensed energy values that is indicative of at least one of an on and an off condition associated with the sensed energy may significantly reduce deployment related costs and time while increasing confidence in initial logged data of the deployed data logger.

Through a process that is simplified for the user that includes detecting with the data logger energy that is in proximity to the data logger while presenting a representation of the detected energy to a user that the user can rely on for optimizing placement of the data logger to enable capturing a plurality of energy values for determining a range of energy values from a portion of the plurality of energy values that are indicative of at least one of an on and an off condition associated with the energy, an auto calibration enabled data logger as described herein may provide significant additional benefits including reliable data logging operation in a wide range of energy infused environments.

Although the methods and systems described herein are directed at automatic calibration enabled data loggers, basically any sensor that returns a subjective range worth dividing into ‘on’ and ‘off’ states based on environment could benefit from the automatic calibration methods and systems described herein.

In this patent application, reference is made to particular features (including method steps). It is to be understood that all possible combinations of such particular features are contemplated and included in this disclosure. For example, where a particular feature is disclosed in the context of a particular aspect or embodiment, or a particular claim, that feature may also be used, to the extent possible, in combination with and/or in the context of other particular aspects and embodiments.

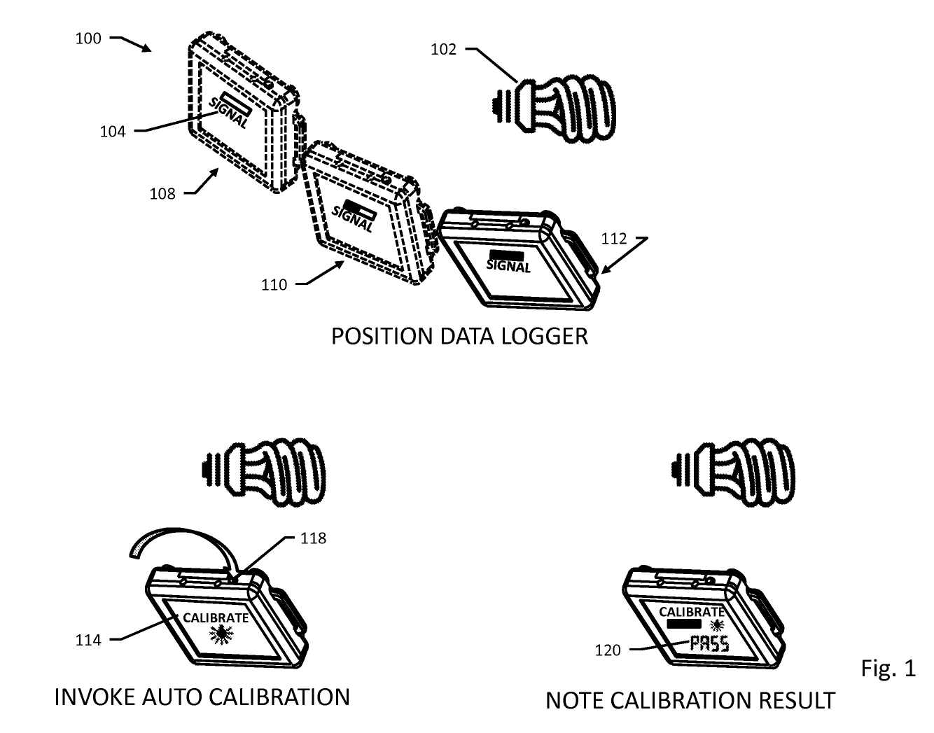

Referring to FIG. 1, which depicts a method of optimizing deployment of a data logger, an auto calibration enabled data logger system may facilitate positioning and orienting a data logger in an environment that ensures that the energy sensor of the data logger receives sufficient energy from an energy source (e.g. a light, motor, and the like) to reliably distinguish between an on condition and an off condition of the energy. In the embodiment of FIG. 1, auto calibration enabled data logger 100 may be moved in an energy field, such as in proximity to a light emitting energy source 102. The auto calibration enabled data logger system 100 may present a representation 104 of energy sensed by the data logger. In the embodiment of FIG. 1, the representation 104 of energy is a bar graph that is presented above a label “SIGNAL”. As a data logger of the auto calibration enabled data logger system 100 is moved from a first position 108 to a second position 110 relative to the light energy source 102, the representation 104 changes appearance to indicate an increase in sensed energy. As the data logger of the auto calibration enabled data logger system 100 is moved from the second position 110 to the third position 112 relative to the light energy source 102, the representation 104 changes appearance to indicate a further increase in sensed energy. The representation 104 is a form of feedback in response to the repositioning of the data logger. Such feedback may be beneficial in determining a suitable position for the data logger to reliably sense a target energy source. With the data logger positioned in a preferred position, such as third position 112, the user may choose to invoke an auto calibration function that further facilitates optimizing deployment of an auto calibration data logger system 100.

Auto calibration enabled data logger system 100 may include a display 114 and an auto calibration input facility 118 (e.g. a push button, momentary button, target on a touch screen, touch sensitive membrane, capacitive switch, or any type of user operable physical input facility). A user may activate the auto calibration input facility 118 to invoke a sophisticated algorithm for automatic energy sensing, data differentiating, and processing to determine a range of energy values that may indicate at least one of an on and an off condition associated with the energy (e.g. light 102 on/off). The automatic calibration function, an example of which is described herein, may execute on the auto calibration enabled data logger system 100 and result in a valid calibration that may be indicated by presenting “PASS” 120 on the display 114. An invalid calibration may be indicated by presenting “FAIL” on the display 114. Because the data logger of the auto calibration enabled data logger system 100 has been deployed for reliable on/off condition sensing, upon completion of automatic calibration, the data logger may commence automatic detection of changes between an on-condition of the sensed energy and an off-condition of the sensed energy. In the embodiment of FIG. 1, an automatically detected on-condition may indicate that light 102 is on (e.g. emitting light) and an automatically detected off-condition may indicate that the light 102 is off (e.g. not emitting sufficient light to be deemed to be “on”). Because the determination of a range of values that indicate the on-condition of the light is based on the actual light being sensed, data logging may proceed with a high degree of reliability.

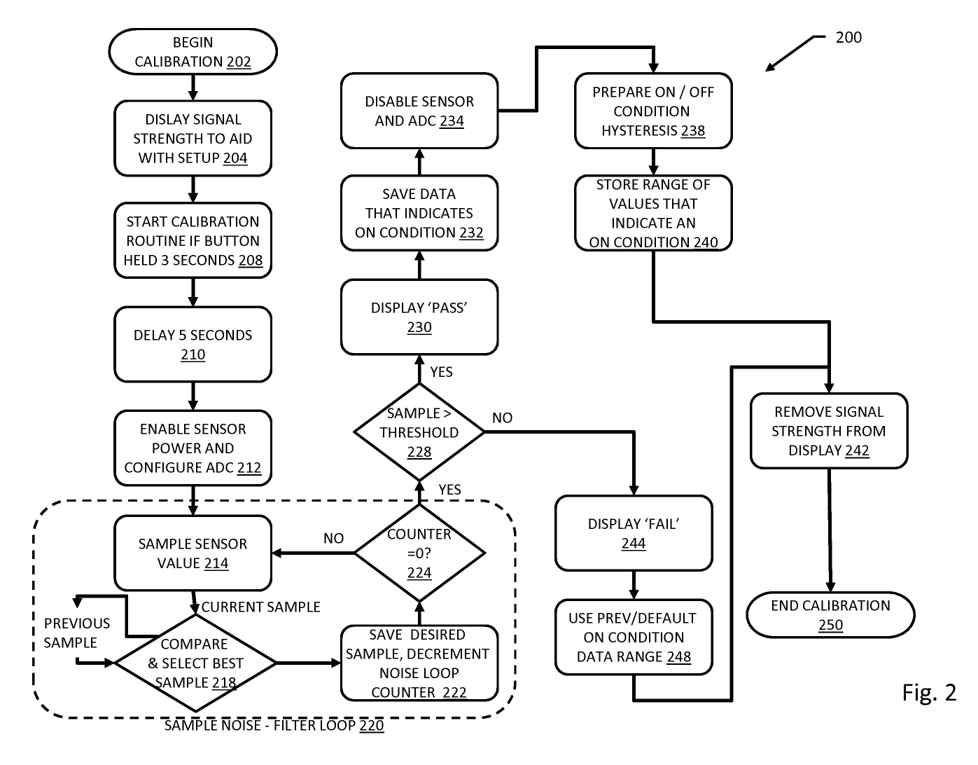

Referring to FIG. 2, which depicts a flow diagram of a method of determining at least one of an on and an off condition of sensed energy, a multi-step process of automatic calibration is presented. A calibration function 200 may be initiated at step 202 in response to an indication of calibration, such as in response to a user activating an automatic calibration invocation facility 118. The automatic calibration function 200 may continue with optional step 204 in which a visual display is updated to indicate a strength of a sensed energy (e.g. signal) to aid with optimizing deployment. Step 204 may be optional because a representation of signal strength may be presented prior to receiving the user indication of automatic calibration invocation. Alternatively, the signal strength indicator may be presented when the user activates the automatic calibration input facility (e.g. button) for less than a minimum amount of time to initiate automatic calibration, such as if the user presses and quickly releases a calibration button on the automatic calibration enabled data logger 100. With the representation of the sensed energy signal presented to the user, the method may proceed to step 208 where the calibration invocation input facility is monitored for continuous activation for more than a minimum amount of time. In an example, if the calibration invocation input facility 118 is activated continuously for more than three seconds, the automatic calibration method may proceed to step 210 which may simply be a delay to enable the user to remove any potential energy sensing disturbances. By way of example, the user's hand may partially obscure a light sensor of the data logger to activate the auto calibration function; therefore delaying auto calibration for a few seconds (e.g. 5 seconds) may be sufficient for a user to move his hand from potentially obscuring the operation of the data logger. Generally, the delay allows a user to move away from the data logger before automatic calibration samples are captured. While a delay of five seconds is shown in FIG. 2, longer or shorter delays may be appropriate and are contemplated as possible in delay step 210.

Upon completion of the automatic calibration delay, one or more sensors of the data logger may be enabled, activated, powered-up, or more fully energized to facilitate capturing energy values from the data logger sensor in step 212. Also in step 212 circuitry for capturing energy for determining at least one of an on and an off condition may be activated and/or configured. In an example, the data logger may include an analog to digital converter (ADC) that may be configured during step 212. Note that the actions taken in step 212 may be taken at an earlier time, such as during any previous step in this method and/or before any steps in the method of FIG. 2 are taken. In such a case, step 212 may be optional or may comprise verifying proper sensor and circuitry operation, such as by checking a data logger configuration status that may be stored in a processor accessible memory. Activating some sensors (e.g. light sensor) well ahead of when the first on/off condition candidate sample is going to be taken may be beneficial to ensure that the sensor has had sufficient time to adjust to ambient conditions (e.g. temperature). Therefore activating such sensors ahead of the calibration startup delay may be useful.

Once the functions described in steps 202 through 212 are complete, samples of sensor data may be captured in step 214. Steps 218, 222, and 224 along with step 214 may comprise a sample noise filter loop 220 that captures and checks a sequence of sensor data captured values to ensure that noise or periodic fluctuation in the energy being sampled by the data logger that is not indicative of the desired on/off condition can be detected and eliminated from the calibration process. Step 214 may capture a sample and save it for use in comparison step 218. Each time a sensor value is sampled in step 214, the previously sampled value is saved for use in step 218 to compare the current and previous samples. Step 218 compares the two samples to facilitate detecting undesired sample values. Step 222 in the noise filter loop 220 may save one or more desired sample values based on the comparison of step 218. The one or more saved sample values may be used in later steps of this automatic calibration process 200. Step 222 and 224 combine to determine if more samples for avoiding undesired sample values are needed. Note that step 222 indicates that a counter is decremented and step 224 checks the counter for a zero condition. While these two steps indicate that a counter function is used (e.g. a count of samples), other types of loop control (e.g. time-based, event based, data based, and the like) may apply to control the sample noise filter loop 220. In an example, the sample noise filter loop 220 may be configured to ensure that enough samples are captured to avoid undesired sample values associated with a 60 Hz fluctuation that may be present in a sampled signal due to AC line voltage variation, and the like. In another example, some types of lighting cycle through a full on and off range of light output but with a very short off duty cycle that is not readily perceptible by the human eye. Energy from such lights (e.g. high intensity discharge lamps) may be sampled during the short off portion of the duty cycle. Samples that are captured during this short off time may be unsuitable for calibration; therefore these samples may be removed from consideration as candidates for an on/off condition value.

Upon completion of the sample noise filter loop 220, one or more data values may be compared in step 228 to an automatic calibration minimum value threshold. This minimum calibration threshold may be based on preset values that may be configured during a production testing or setup operation. The minimum calibration threshold may be based on user inputs so that a user or installer of the automatic calibration enabled data logger system 100 may influence an acceptable calibration threshold. A minimum calibration threshold may be based on the type of sensor, type of data logger, desired confidence level in the calibration, hardware aspects of the data logger, type of energy being sensed, overall energy level expected to be available for calibration, and the like. Generally, there is a hardware-based minimum calibration threshold below which calibration reliability may be unacceptably compromised. Typically, the calibration threshold applied in step 228 is equal to or greater than the hardware-based threshold.

If the result of comparison of the one or more samples that are passed out of the sample noise filter loop 220 into the threshold comparison step 228 indicate that the sample is not acceptable (e.g. equal to or above the calibration threshold), the next step in the method may be step 244 in which the user is notified that calibration was not acceptable (e.g. by displaying “FAIL” on a screen that is accessible by the user, logging a calibration failure condition, transmitting an indication of such result, or the like). To ensure that an automatic calibration enabled data logger system 100 maintains at least a default calibration, step 248 may follow step 244 so that a valid calibration value(s) is saved for use by the data logger. Such a valid calibration value(s) may be any of a factory default value, a previous valid calibration value, a user specified calibration value, and the like. Upon completion of step 248, the automatic calibration method 200 of FIG. 2 may include one or more cleanup actions as indicated in step 242, such as changing a display to no longer display calibration related data (e.g. signal strength, calibration result, and the like) and then the process may end at step 250. A user may choose to restart the automatic calibration method 200 and/or adjust a position of the data logger before doing so. Alternatively, a user may choose to take no action and the calibration value(s) selected in step 248 will be made available to the data logger for detecting on and/or off states associated with a sampled energy.

If the result of comparison in step 228 is an acceptable calibration sample value, the user may be notified of successful calibration sample capture in step 230 (e.g. by displaying “PASS” on a screen accessible to the user, logging a calibration pass condition, transmitting an indication of such result, or the like). The user may confidently conclude that deployment of the data logger is sufficiently optimized to ensure that detection of on and/or off states can reliability use the calibrated value.

In step 232 data that indicates at least one of an on and an off condition associated with the sampled energy values may be stored. This data may be a single sample value, a range of sample values, a set of sample values, and the like. Generally at least one sample value is saved for associating with at least one of an on and an off condition.

Step 234 shows action is taken to disable the sensor and/or analog to digital converter. Such action may be beneficial to reducing energy consumption of the data logger (which may be battery powered). Step 234 may be optional as some data logger deployments may not be battery powered. However, reducing power typically reduces heat generation so durability of the data logger may be improved through such action. Also there may be other reasons for taking action 234 as well as reasons for not taking action 234. To the extent that step 234 may be optional, all such reasons are contemplated herein and may be included in a decision regarding taking action 234.

With at least one energy value sample stored for indicating at least one of an on and an off condition of a source of the energy (or just of the presence of the energy), a band of energy values may be calculated at step 238 around the at least one energy value that represent at least one of an on and an off condition. This range or band of values may be determined to ensure that small energy sample fluctuation from the energy value determined in step 228 does not falsely indicate that the energy sample indicates an off condition. Generating such a band around the calibration energy value(s) is typically associated with generating hysteresis. A wide range of hysteresis computation algorithms and constraints are possible and all are contemplated within the scope of this disclosure. Some constraints for hysteresis computation may include tolerance in fluctuation of the sensed energy. Such fluctuation may be based on the energy source, the sensor sensitivity and/or repeatability, the calibration value, proximity of the calibration value(s) to the calibration minimum threshold, desired tolerance for logging a transition from an on/off to an off/on condition, and the like. A hysteresis band may be calculated based on various rules that may relate to user preferences, device features and/or capabilities, factory testing results, service access to the deployed data logger, type of sensed energy, deployment environment, nominal detected energy value, minimum detected energy value, and the like. Hysteresis may be computed for values above the calibration value(s) differently that for values below the calibration value. Based on the calibration value(s) and/or the computed on/off condition hysteresis band, an off condition value and/or range of values may be computed. Similarly, hysteresis of the off condition value may be computed and stored along with at least one of an on condition and an off condition value(s) and hysteresis for facilitating detecting on and/or off conditions with the data logger.

Step 240 may simply provide a storing function for the calibration value(s) and/or hysteresis band or range of values associated with at least one of an on and an off condition. Similarly as noted above off condition value(s) and/or hysteresis band or range may be stored during step 240.

Step 242 may provide an optional clean-up set of actions related to adjusting a display of signal strength that may be suitable for use during deployment and calibration but may not be necessary to continue to display once calibration is complete. Calibration may end at step 250.

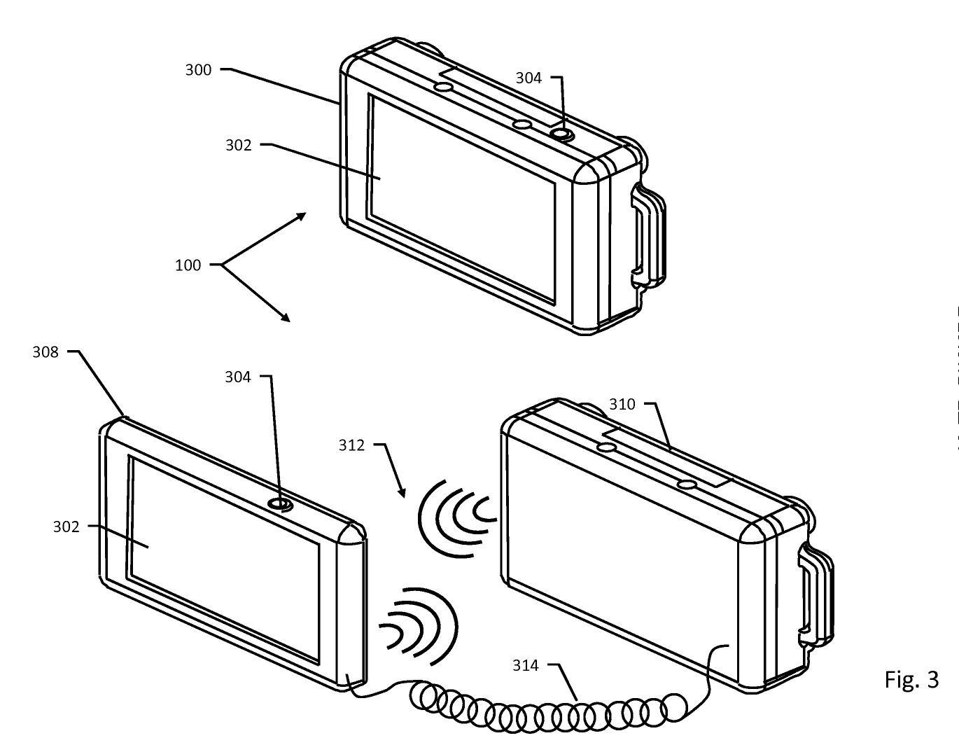

Referring to FIG. 3, various embodiments of an automatic calibration enabled data logger system 100 are depicted. Data logger system 100 may be an integrated data logger 300, that may include a data logger, calibration related screen 302, calibration invocation interface 304, and automatic calibration features, functions, and capabilities as described herein. Alternatively, an automatic calibration enabled data logger system 100 may be a composite of a plurality of elements, such as a data logger 310 and a calibration interface 308 that may communicate through wired connection 314 or wirelessly 312. In a composite configuration, the calibration interface 308 may include a screen 302 and a calibration invocation interface 304 (e.g. a push button). Alternate configurations may include interfaces other than display 302 and push button 304. Such alternate configurations are described elsewhere herein. Alternatively, calibration interface 308 may be a computing device that also serves another purpose, such as a mobile phone, laptop computer, and the like. Such a calibration interface 308 device may include software that adapts the device to function as a calibration interface for an automatic calibration enabled data logger system 100. It is envisioned that an integrated data logger 300 may be used to provide interface and/or other calibration related functionality for a data logger 310. Data logger 310 may be a data logging sensor that has no integrated user interface. Such a device may communicate (e.g. wirelessly) to a device (e.g. calibration interface 308, a network accessible server, a cloud-enabled device, and the like) that receives data sensed by the data logger 310, facilitates display of the sensed data (e.g. as a signal strength/quality indicator), facilitates interfacing with a user, conducts calibration, and provides calibration result/data to the deployment data logging sensor for use during data logging activity. Such a data logging sensor may include a small memory for storing calibration information and a small number of data logging entries that act as an interim buffer of on/off state changes if or when a communication link between the data logger sensor and a host device is interrupted. Embodiments of the integrated data logger 300 may include a data logging sensor that may communicate over one or more networks (e.g. wireless, WIFI, mobile networks, the Internet, and the like) to one or more cloud computing and/or storage devices. The could computing and/or storage devices may store, compute, facilitate display, calibrate, and the like as described herein. In an example, the integrated data logger 300 may include a data logging sensor, a network interface, a cloud-based server, cloud-based data storage, and a user device (e.g. a mobile phone, central/remote monitoring center, and the like). In the example, the data logging sensor may capture data from the environment, send/and receive commands and/or data to at least the cloud-based server which may facilitate communication with the cloud-based data storage to store the captured data and process the data through the calibration and other algorithms described herein or related to deployment of a data logger. The cloud-based sever may communicate commands and/or data to/from the user device so that a user may interact with the data logging sensor in the environment to facilitate the detection of energy that indicates at least one of an on condition and an off condition associated with energy in the environment. Such configuration may alternatively include an automatic calibration-enabled data logger such as data logger 300 in place of the data logging sensor.

An automatic calibration enabled data logger system 100 may include a processor (e.g. PIC or micro PIC controller), memory, power supply (e.g. battery), energy sensor, interface circuitry (e.g. wireless capability), housing, mounting features, display, audible indicator, user interface features, and the like. Energy that is present in proximity to the data logger may be sensed by the energy sensor and processed through circuitry and/or software with a processor to be stored in memory (e.g. PIC integrated memory or external memory). Alternative to storing sensed energy related information in a local memory, the information could be transmitted to an external device (e.g. hand-held device, laptop, desktop, sever, and the like) that may be in proximity or may be distally located relative to the data logger. Such memory stored data may be used during calibration to determine an on-condition value and may be used after calibration (e.g. during run time) to determine when the sensed energy indicates that at least one of an on condition and an off condition is no longer satisfied which may indicate that a source of the energy is no longer on or that the energy can no longer reach the sensor due to some interference (e.g. cloud cover, night fall for sunlight detection).

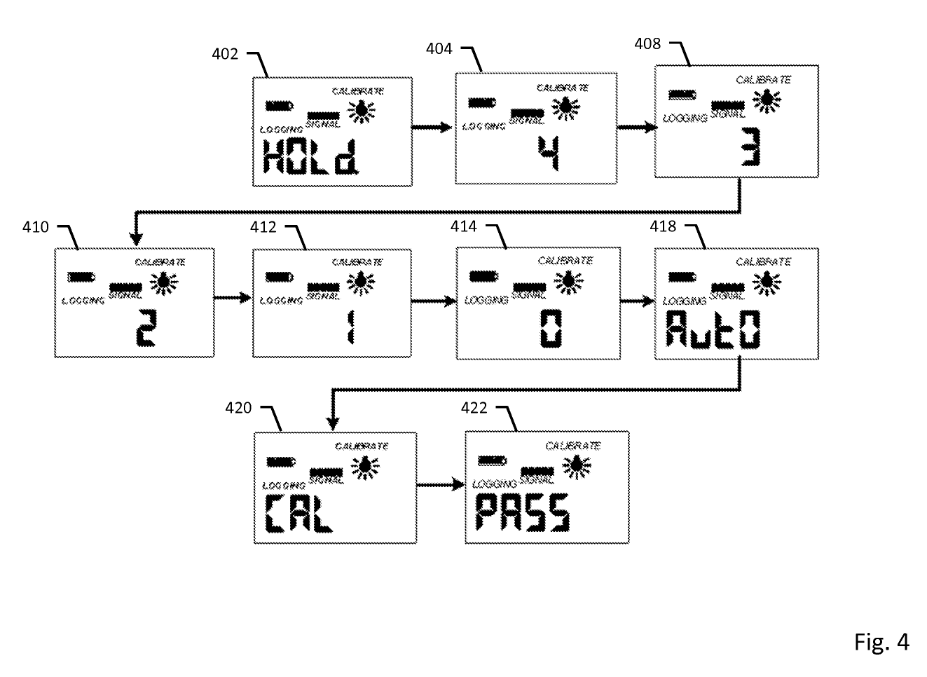

Referring to FIG. 4, a sequence of screen shots during automatic calibration is depicted. The sequence starts at screen 402 typically as a result of a user invoking automatic calibration. The screen indicates calibration has been invoked through the “CALIBRATE” text and accompanying signal. As noted above herein, an indication of signal strength may also presented to the user. This signal strength indicator may represent sample values being captured by the energy sensor of the data logger. The signal strength indicator may also represent the quality, not just the quantity, of the signal. For example, if the reading was large but highly variable, it might be better to show an indication of the variability of the measurement. A signal strength indicator may be depicted as a scale of detectable energy. Initially in screen 402, the user is notified that the calibration delay function has been started through display of “HOLd”. The calibration delay function progresses through a countdown shown in screens screen 404, 408, 410, 412, and 414. Upon completion of the calibration delay function, screen 418 indicates that automatic calibration sampling has begun with the display of “AutO”. Automatic calibration continues with screen 420 that displays “CAL”. The screen shots associated with automatic calibration concludes with a status of calibration 422. In the example of FIG. 4, automatic calibration status is indicated by display of “PASS”.

Although FIG. 4 depicts a screen that can present a variety of information visually to a user, a calibration interface may include a screen and/or other forms of user notification regarding calibration state, result, signal strength, and the like. Screen technology that may be used may include, without limitation, LED, LCD, touch screen, and the like. Various visual indicators may be used such as various color lights (e.g. LEDs), arrays of lights that may enable display of patterns, sequencing of one or more lights that may enable display of an encoded sequence (e.g. similar to Morse code), and the like. Various audio indicators may be used for notifying a user of signal strength, calibration state, calibration result, and the like. Audio indicators may include a range of sounds, pitches, volumes, tones, repetition rates, tone lengths, and the like to indicate signal strength, calibration state, and the like.

A signal strength indicator may be depicted as a graph (e.g. bar, pie, half-tone field, etc), a data value (e.g. numbers, quantity of elements), a color range, sound, and the like. The signal strength indicator may be threshold activated so that a change in the representation of signal strength is based on being above or below a threshold. The signal strength indicator may display a first color prior to calibration, a second color during calibration, a third color after successful calibration, and a fourth color after unsuccessful calibration. Once calibration is complete, the signal strength indicator may reflect the sensed on/off state of the energy being sensed.

A signal strength indicator may provide the user with information about the potential for a successful calibration. In an example, the signal strength indicator may be reflective of a percentage of a possible detection range of the sensor. In this way, rather than the signal strength indicator simply being converted from a sensed value, it may indicate a potential calibration value as a percent of the range of detectable values. The signal strength indicator may relate to a potential for successful calibration in that a minimum calibration threshold may be factored in to the signal strength indicator display algorithm so that the indicator shows no signal strength if the sensed signal is below the minimum calibration threshold. As described above, this threshold may be based on a wide range of factors including device, programming, user, signal, environment, and the like.

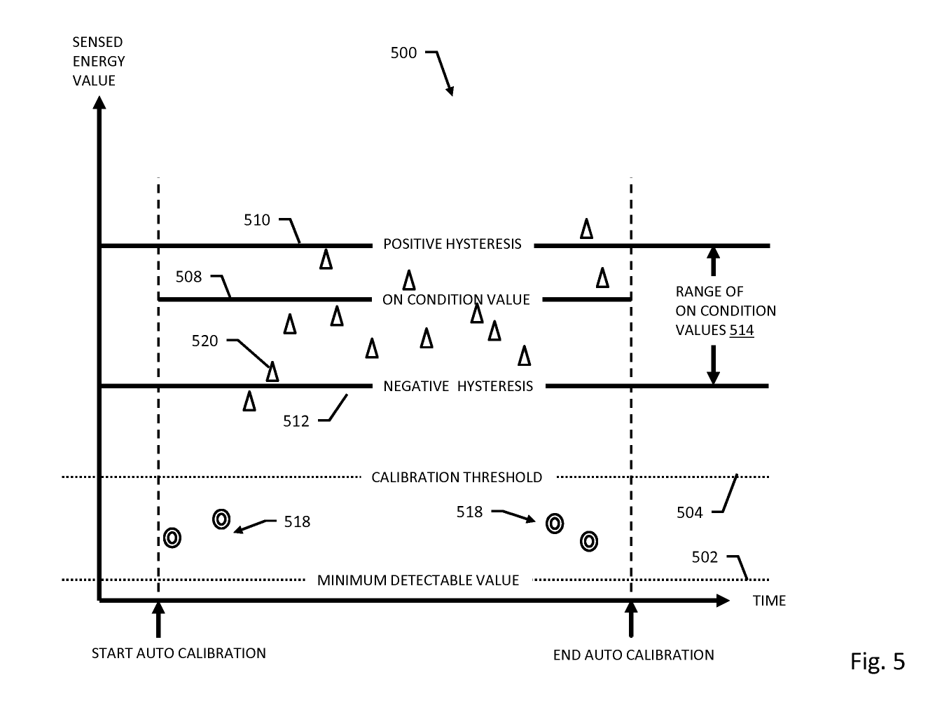

Referring to FIG. 5, a chart of sensor sample data values in context of automatic calibration for detection of a range of values that indicate at least one of an on and an off condition is presented. The chart 500 includes an x-axis of sample time and a y-axis of sample value which may be a representation of energy that is being sensed by a sensor of an automatic calibration enabled data logger system 100. Depicted in the y-axis direction are several thresholds including a minimum detectable value 502 that may be determined as described herein based on hardware capabilities of the data logger; a calibration threshold 504 that may be determined from a variety of factors as described herein; at least one of an on and an off condition value 508 that is above the calibration threshold and may represent one or more sample values associated with at least one of an on and an off condition of the energy being sampled by the data logger; positive hysteresis 510 and a negative hysteresis 512 values associated with at least one of an on condition and an off condition value 508. The range of values between the negative hysteresis 512 and the positive hysteresis 510 may comprise a range of on/off condition values 514. Hysteresis may incorporate time so that changes in sensed energy value that occur within and/or outside of a range, or time of occurrence of certain values may impact a determination of the sample value representing a change in a sensed on/off condition.

Undesired samples 518 are shown below a calibration threshold and values that may be considered as candidates 520 for establishing at least one of an on and an off condition value 508 are shown above the calibration threshold. In this example, at least one of an on and an off condition value 508 is determined based on the candidate samples 520 and hysteresis is determined from at least at least one of an on condition and an off condition value taking into consideration other factors that may be related to providing long-term reliable on/off condition sensing.

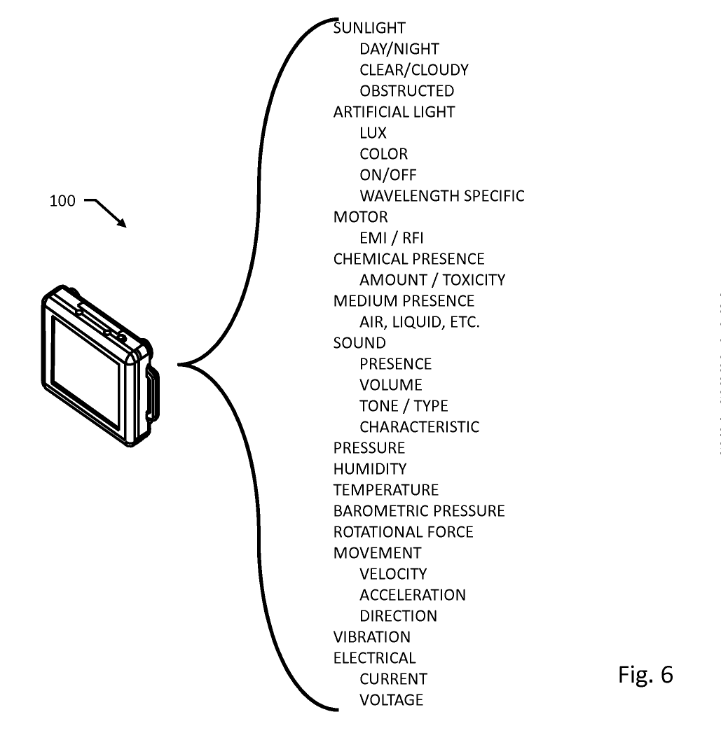

Referring to FIG. 6 various deployment environments of an automatic calibration enabled data logger are depicted. Exemplary environments, while not limiting include Sunlight (day/night, clear/cloudy, obstructed, and the like), Artificial Light (lux, color, on/off, wavelength specific, narrowband UVB, and the like), Motor (emi, rfi), Chemical presence (amount, toxicity), Medium presence (air, liquid, etc), Sound (presence, volume, tone/type, characteristics, etc), Pressure, Humidity, Temperature, Barometric pressure, Rotational force, Movement (velocity, acceleration, direction), Vibration, Electrical (current, voltage), and the like.

In an example, detecting at least one of an on and an off condition of a motor to automatically calibrate a data logger may include sensing an electromagnetic energy field produced by the motor when it is operating. Although motors vary in the amount of electromagnetic energy that is detectable in proximity to the motor, some motors include shielding explicitly to limit the escape of electromagnetic energy from the motor housing. In addition, electromagnetic energy from other sources (an AC line, other equipment, a nearby transformer, and the like) may be present and detectable by the data logger. In such situations, greater sensitivity and orientation of the sensor relative to the motor housing may be important considerations for reliable on/off data logging. In this regard, by using the signal strength indicator, a user may position the data logger at an optimal position for detecting the motor's electromagnetic energy output. By adjusting the position of the data logger, the user may be able to dispose the data logger so that the electromagnetic energy produced by the motor may be detectable from the general background electromagnetic energy.

In another example, detecting at least one of an on condition and an off condition in an environment to automatically calibrate a data logger may include sensing vibration. Vibration by itself may be sensed or vibration may be sensed as an indication of another type of energy, such as sound. In an environment with a very loud ambient noise level, detecting vibration in association with a targeted sound for logging may provide more reliable results than simply attempting to detect sound.

While the invention has been disclosed in connection with the preferred embodiments shown and described in detail, various modifications and improvements thereon may become readily apparent to those skilled in the art. Accordingly, the spirit and scope of the present invention is not to be limited by the foregoing examples, but is to be understood in the broadest sense allowable by law.

1. A method of optimizing deployment of a data logger, comprising:
detecting with the data logger energy that is in proximity to the data logger;
presenting a representation of the detected energy to a user;
receiving an indication of deployment optimization while presenting the representation of the detected energy to the user;
capturing a plurality of energy values in response to receiving the indication of deployment optimization; and
determining a range of energy values from a portion of the plurality of energy values that are indicative of an on condition associated with the energy.

2. The method of claim 1, further including storing a range of data values that are indicative of the on condition in the data logger.

3. (canceled)

4. The method of claim 1, wherein determining a range of energy values that indicate an on condition associated with the energy includes:
filtering out values below a minimum calibration threshold;
determining a nominal value of the non-filtered values; and
applying a hysteresis rule to generate the range of energy values.

5. The method of claim 1, wherein the range of energy values includes hysteresis associated with the on condition.

6. The method of claim 5, wherein the hysteresis is based on predetermined parameters.

7-9. (canceled)

10. The method of claim 5, wherein the hysteresis is determined based on a hysteresis determination rule.

11. (canceled)

12. The method of claim 1, wherein presenting a representation of the detected energy includes presenting the detected energy on a scale of detectable energy.

13-23. (canceled)

24. The method of claim 1, wherein the detected energy is electromagnetic energy.

25. The method of claim 1, wherein the detected energy is emitted from a source.

26. The method of claim 25, wherein the source emits electromagnetic energy.

27. The method of claim 1, wherein receiving an indication of deployment optimization includes receiving user input.

28-54. (canceled)

55. A data logger for automatically detecting an on condition, comprising:
a sensor for detecting energy that is in proximity to the data logger;
an output facility for presenting a representation of the detected energy to the user;
an input facility for facilitating user input; and
a processor for detecting the user input, capturing a plurality of energy values via the sensor in response to the detected user input, and processing a portion of the captured plurality of energy values to determine a range of energy values that are indicative of an on condition associated with the energy.

56. The data logger of claim 55, further including a storage facility for storing the range of energy values that are indicative of the on condition in the data logger.

57. The data logger of claim 55, wherein the range of energy values includes hysteresis associated with the on condition.

58. The data logger of claim 57, wherein the hysteresis is determined based on a hysteresis determination rule.

59. The data logger of claim 55, wherein a representation of the detected energy includes an energy scale representation on an electronic display and wherein the scale is a bar graph.

60. A method of optimizing deployment of a data logger, comprising:
positioning a data logger that is capable of automatically determining a range of energy values that indicate an on condition associated with energy that is in proximity to the data logger;
viewing a representation of energy that is detected by the data logger while the energy is being detected by the data logger;
adjusting a position of the data logger so that the representation is maintained above a minimum auto-calibration threshold; and
signaling to the data logger to begin auto calibration.

61. The method of claim 60, wherein a representation of the energy that is detected by the data logger indicates a potential nominal value associated with the on condition.

62. (canceled)

63. The method of claim 60, wherein a representation of the energy that is detected by the data logger includes an indication of quality of the energy.

64. The method of claim 60, wherein the energy that is detected by the data logger is electromagnetic energy.

65-133. (canceled)
